(19) United States
(12) Patent Application Publication
(10) Pub. No.: US 2007/0231113 A1
(43) Pub. Date: Oct. 4, 2007

(54) Apparatus and method for lifting and transporting a container with an independent mechanized unit

(76) Inventor: Arthur S. McGurn, Manakin-Sabot, VA (US)

Correspondence Address: JOHN H. THOMAS, P.C., 536 GRANITE AVENUE, RICHMOND, VA, 23226, US

(21) Appl. No.: 11/373,347

(22) Filed: Mar. 10, 2006

(51) Int. Cl. B65G 1/00; B65G 65/00

(52) U.S. Cl. 414/281

(57) ABSTRACT

The invention relates to an apparatus and method for the transportation and delivery of a portable storage unit. The apparatus includes a frame with selectively controllable dimensions to lift and lower the portable storage unit. A separate power source links with the frame in order to provide a means to actuate the frame's dimensions. The independent power source is also self-propelled and is operable to push, pull, or otherwise relocate the frame across a surface. The frame storage unit, and/or power unit are loaded onto a road vehicle in order to transport them between various work or storage sites. The frame, in one preferred embodiment, includes hydraulic cylinders that work to change the dimensions of the frame, and the hydraulics are activated and controlled via a hydraulic connection with the mechanized power unit.

The present invention relates to a method and apparatus for lifting and relocating containers. More specifically, the apparatus and method provide a frame and a independent mechanized/power unit that combine to deliver a portable and temporary storage option.

### BACKGROUND

The temporary storage industry, also known as the self-storage industry, is a multi-billion dollar industry serving the needs of an increasingly consumptive and mobile public. The most common type of self-storage is a secure location where paying subscribers or renters are allowed access in order to place their possessions or goods in individual storage units. The customer is responsible for locating a reputable storage provider and transporting their goods to the remote site. The customer can pick up or deposit goods as needed, but the storage provider's only service is to provide a secure location for the customer. These remote storage units may not be readily accessible to the customer. In addition, temporary use of off-site storage, for instance where a customer is temporarily storing their possessions during a relocation, introduces additional loading and unloading steps to the relocation process.

More recently, storage customers have begun a shift to on-site storage wherein containers of various sizes are delivered to the customer. The increased convenience and accessibility benefit the customer. The storage provider also has decreased overhead (real estate taxes, liability, etc.). On-site storage allows a customer to store their possessions that do not fit in the customers structure, either commercial or residential. It should be noted that storage customers range from residential renters and home owners up to commercial entities who need piecemeal storage solutions.

Another benefit of providing on-site storage is that once the goods are stored, the container can be moved directly to a remote storage facility or to any other location at the customer's request. These containers are generally relatively small in order to be lifted by fork lifts. On-site storage eliminates the extra loading and unloading steps required by off-site storage.

In many instances, in both residential or commercial applications, there exists a need for a large size storage container that cannot be transported by conventional means. The on-site storage industry is relatively new, but it has encountered problems with transporting these containers to the site, unloading the containers from the transport vehicle, and maneuvering the container into the desired position. Forklifts are inadequate and cranes are cost prohibitive. The delivery process also must be reversed when the container is to be removed from the site. The method of delivering the container must be low impact to the customer's site while offering a secure means to transport the goods. The delivery method should also keep the load level without excessive tilting.

In response to this recognized need, one industry solution has been the creation of a motorized frame for lifting and handling a storage container, loading it onto a vehicle, transporting it to a given location, and unloading the container from the vehicle. The typical solution is to have the motor on the frame, which increases the complexity of the frame. Drive shafts and other components must be integrated into the frame to handle the integral power unit. In addition, steering components must be built into the frame. All the parts that must be integral to the frame means increased complexity and that any maintenance problems for the mechanized portion of the frame disables the entire frame. Mounting the motor on the frame also leads to a potentially unbalanced frame, among other issues.

Therefore, there exists a need for an apparatus and method that provide a separate frame and power unit that combine to deliver a portable and temporary storage option. It is preferred that such an apparatus and method would allow for a separate, self-propelled power unit that selectively links to the frame. An apparatus for lifting and transporting a container with an independent mechanized unit in accordance with the present invention allows a temporary storage container to be transported or otherwise delivered in a more efficient and reliable manner. The independent power/mechanized unit increases mobility in at least some circumstances and can be quickly exchanged for another unit. As described below, the present invention builds upon conventional concepts, methods and designs of the prior art, but it provides an original apparatus and method for improving the prior art.

### SUMMARY OF THE INVENTION

In accordance with the present invention, an apparatus and method are provided for the transportation and delivery of a portable storage unit. The apparatus includes a frame with selectively controllable dimensions to lift and lower the portable storage unit. A separate power source links with the frame in order to provide a means to actuate the frame's dimensions. The independent power source is also self-propelled and is operable to push, pull, or otherwise relocate the frame across a surface. The frame storage unit, and/or power unit are loaded onto a road vehicle in order to transport them between various work or storage sites. The frame, in one preferred embodiment, includes hydraulic cylinders that work to change the dimensions of the frame, and the hydraulics are activated and controlled via a hydraulic connection with the mechanized power unit.

In greater detail, the frame is supported by wheel assemblies. The height, width, and length dimensions of the frame are defined by four vertical corner posts defining two sides and two ends. Each vertical post is located at each of the four corners with a selectively pivotable wheel assembly supporting the post. A cross-member is positioned on each side of the frame, and each cross-member connects to the two adjacent corner posts defining one side of the frame. End-tubes are located on each end of the frame, and each end-tube is connected to the two adjacent corner posts defining one end of the frame.

The height of the frame is variable in that each of the vertical posts includes a selectively extendable or retractable leg to change the vertical height of the frame. In addition, each of the end-tubes includes a selectively extendable or retractable tubular element to change the width of the frame. Therefore, the height and width dimensions of the frame can be controlled.

The ability to vary the dimensions of the frame renders the frame operable to lift and position a storage unit. The frame is sized to substantially fit around the dimensions of the portable storage unit. At least one connector selectively secures the frame to the portable storage unit. Once the connection is made, the legs are extended from the posts until the frame lifts the storage unit off the ground.

In order to position the storage unit, the self-propelled, wheeled power unit is selectively secured to a hitch mount located on the frame. In addition, couplings from the power unit provide the hydraulic or other force necessary to change the dimensions of the frame from the power unit to the frame. The self-propelled mechanized unit also pushes, pulls or otherwise positions the wheel-supported frame across a surface.

The apparatus and method to deliver a portable storage option of the present invention effectively address at least one of the problems associated with prior art storage delivery systems. For instance, the storage delivery system of the present invention includes a readily exchangeable power source and propulsion method that eliminates or minimizes maintenance down-time associated with prior art storage delivery systems. The frame is less complex, and less expensive to manufacture. The foregoing and additional features and advantages of the present invention will become apparent to those of skill in the art from the following detailed description of a preferred embodiment taken in conjunction with the accompanying drawings.

### BRIEF DESCRIPTION OF THE DRAWINGS

FIG. 1 is a side view of a wheeled frame hitched to a self-propelled, wheeled power unit in accordance with one embodiment of the present invention;

FIG. 2 is an end view of the wheeled frame hitched to the power unit of the present invention wherein the frame is illustrated in a lowered position so that a portable storage unit rests on the ground;

FIG. 3 is a close-up view of a hitch assembly operable to selectively hitch the self-propelled power unit to the wheeled frame in accordance with one embodiment of the present invention;

FIG. 4 is a side view of the wheeled frame unit in a raised position wherein a portable storage unit is lifted off of the ground;

FIG. 5 is an end view thereof and further illustrates the ability to change the width dimensions of the wheeled frame;

FIG. 6 is a cut-away end view that illustrates internal features of the wheeled frame in a lowered position;

FIG. 7 is a cut-away end view that illustrates internal features of the wheeled frame in a raised position;

FIG. 8 is a perspective view of the wheeled frame positioned on a transport vehicle;

FIG. 9 is a perspective view of the wheeled frame positioned on a transport vehicle wherein the wheeled assemblies are extended to lift the frame off of the transport vehicle;

FIG. 10 is a perspective view of the wheeled frame in a raised and widened position in order to fully disengage the frame from the transport vehicle; and

FIG. 11 is a perspective view of the wheeled frame selectively hitched to the self-propelled, wheeled power unit wherein the frame is disconnected from a portable storage unit.

### DETAILED DESCRIPTION

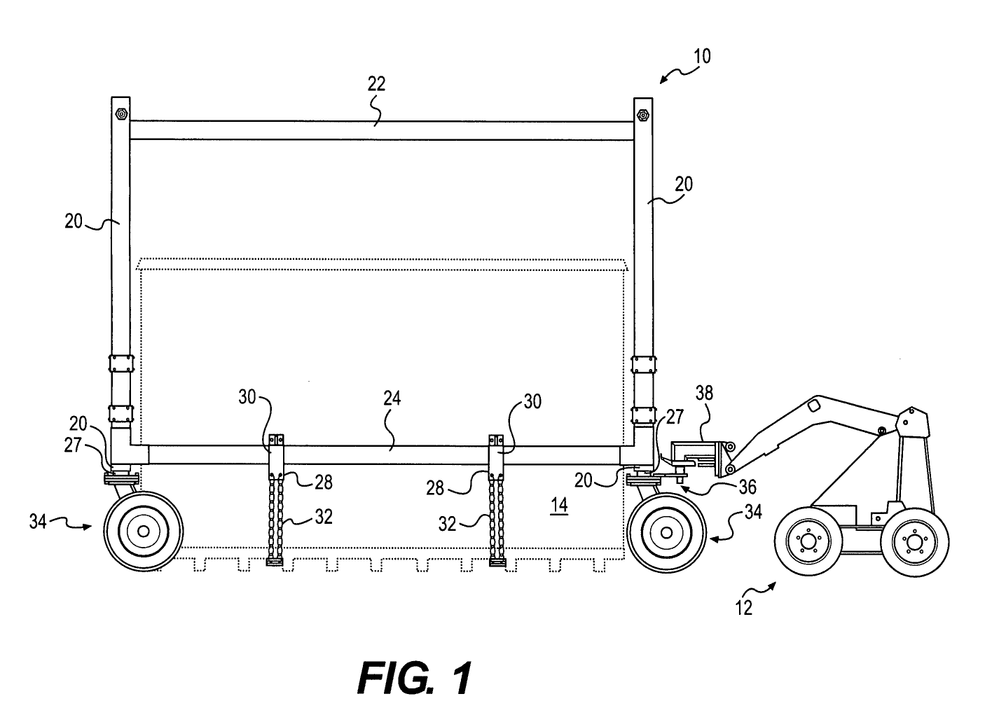

Turning now to a detailed description, FIGS. 1 through 11 illustrate one or more preferred embodiments of the present invention. Naturally, an engineer having ordinary skill in the art will be able to create a storage delivery system that incorporates the teachings of the present invention, but which may look different and incorporate different, alternative parts. The inclusion of a self-propelled power unit to provide energy and locomotion, among other features, creates a storage delivery system that is efficient and unique. The apparatus and method improves upon out-dated systems using integrated power units, integrated drive and steering means, and other unnecessary components.

With reference to FIG. 1, there is illustrated an apparatus for lifting and transporting a portable storage container including a wheeled frame 10 and an independent, self-propelled power unit 12. Frame 10 is dimensioned to surround a portable storage container, which is illustrated as element 14. Container 14 is represented in broken lines as the size, shape, or construction of the storage container do not form a significant part of the invention. Typically, however, such containers have rectangular dimensions and are seven or more feet tall. The containers are generally fully enclosed so as to operate as long term storage solutions. A door allows access into one or both ends of the container.

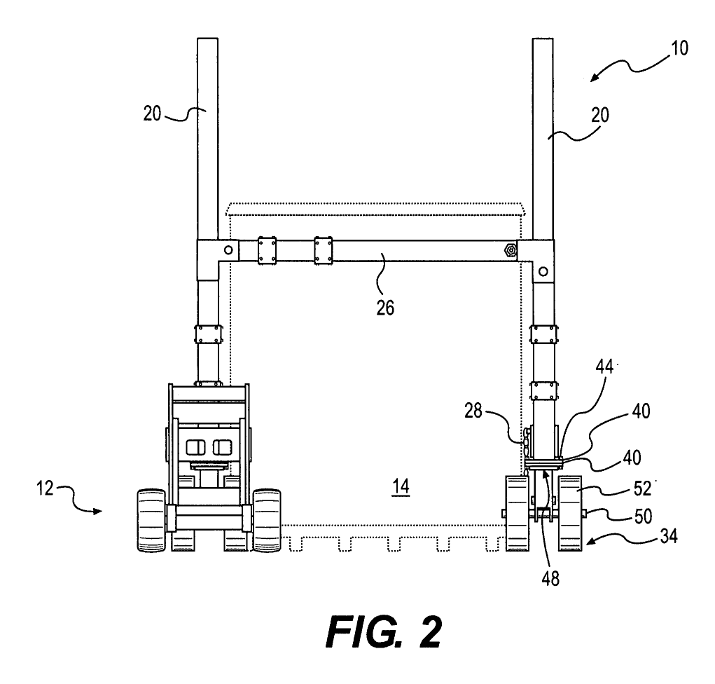

Overall, frame 10 is rectilinear with four corners defined by vertical posts 20 so that the frame has two sides and two ends. The frame, including the posts, is comprised of hollow tubes, and the tubes are joined by brackets, welds, or otherwise secured together. At least one tube is used to adjoin each adjacent post in order to provide structural integrity. As such, one or more cross-members are provided on each side of the frame. As illustrated, a preferred embodiment includes upper and lower cross-members 22, 24 connected at each end to the two posts defining one side of the frame (i.e., there are four cross-members in total). End-tubes also support posts 20 along the end edges of the frame. Referencing FIG. 2, there is illustrated an end-tube 26. Each end of frame 10 would include at least one end-tube spanning the distance between the vertical posts that define the ends of the frame.

The various joints and connections between the posts 20, cross-members 22, 24, and end-tubes 26 can be accomplished via techniques known in the art. In addition to the above frame construction, each post surrounds and is in a relatively slidable relationship with a leg 27. Each leg extends from, or retracts into, the lower end of the corresponding vertical post 20. Energy provided by the power unit 12, such as hydraulic pressure, is operable to extend or retract leg 27 relative to the post. Legs 27 can be fully retracted into post 20. The end-tubes also include an internal member wherein the end-tubes are moveable in relation to the internal members. The width of the frame is controlled via the position of the end tubes relative to the internal members, as will be discussed further below.

Frame 10 is selectively coupled to container 14 via one or more connectors 28. In a preferred embodiment, connectors 28 comprise brackets 30 that clamp or are otherwise secured to lower cross-members 24. A chain 32 is secured to each bracket at a first end and to the container at a second end. Extending legs 27 lifts the frame. FIG. 1 illustrates that legs 27 have been extended to the extent that chain 32 is taunt but container 14 remains resting on the ground/surface. The further extension of legs 27 results in container 14 being lifted off of the ground by the frame via the connectors 30. It should be understood that many different types of connectors are available and would be obvious to one of skill in the art.

Each leg 27 and post 20 assembly is supported by a selectively pivotable wheel assembly 34. At least one leg includes a hitch mount 36 to which the wheeled power unit can be selectively coupled. In one preferred embodiment, a hitch mount is provided on a pair of opposing posts 20. The propulsion provided by power unit 12 when power unit 12 is secured to a hitch mount is the motivating force to move and position frame 10.

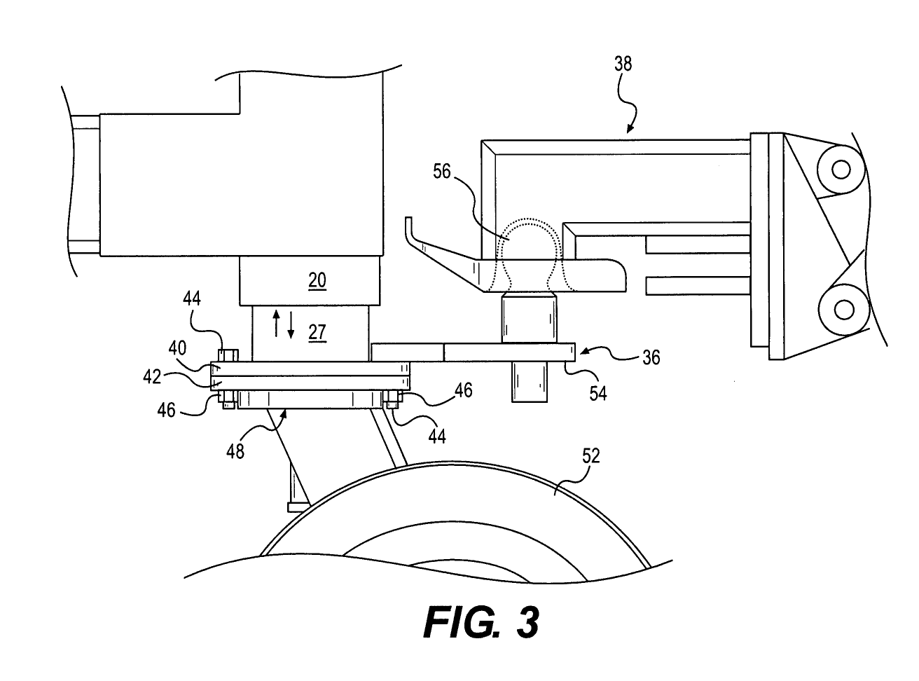

With reference to FIGS. 2 and 3, legs 27, pivotable wheel assembly 34, hitch mount 36, and a receiving hitch 38 are illustrated in greater detail. Legs 27 terminate at their lower end on the exterior of the respective post 20 at a leg plate or flange 40. The upper terminus of legs 27 terminate within posts 20. Each leg plate 40 is effectively a flat surface, arranged perpendicular to the axis of the legs, that extends beyond the perimeter of leg 27.

Wheel assemblies 34 include an upper plate 42 secured to leg plate 40 via known fastening mechanisms such as bolts 44. Plate bolts 44 extend through both the upper plate and post plate. A nut 46 on each bolt 44 holds the bolt in place. Other fastening mechanisms could be used.

Each wheel assembly 34 is effectively a large scale caster. Therefore, a rotating caster assembly 48, as known in the art, provides the ability to rotate the direction of the wheel assembly through 360 degrees of rotation about the axis defined by the leg and post assembly. The rotating caster assembly includes an axle 50 onto which a wheel and tire combo 52 is mounted. The wheel and tires rotate on the axle.

The ability to rotate each wheel assembly independently increases the mobility of frame 10. However, it is often desirable to lock one or more of the rotatable caster assemblies in a specific direction to aid steering the frame. A pin (not illustrated) can be inserted into or through the rotating caster assembly in order to prevent the rotation of caster assembly 48. Locking all four caster assemblies is possible. Safety, noise, and other considerations are thought to make it desirable to lock the caster assemblies when frame 10 is loaded onto a transport vehicle, as will be discussed further below.

As briefly mentioned above, power unit 12 is selectively coupled to a hitch mount 36. One preferred embodiment of the hitch mount is a common ball hitch as known in the art. This preferred embodiment includes a hitch plate 54 that is fastened to a leg plate 40 and/or surrounds leg 27. Hitch plate 54 supports a hitch ball 56. Power unit 12 has a corresponding receiving hitch 38. In this case, hitch receiver 38 engages ball 56. Power unit 12 has a range of rotation about this mounting point. In another preferred embodiment, it is envisioned that a hitch assembly that precludes rotation between the power unit and frame could be used.

One skilled in the art will be able to modify other known hitch assemblies for use with the present invention. Therefore, the present invention should not be limited to the use of a ball hitch mechanism. Moreover, given that multiple hitch mounts on the frame is preferred, the operator can selectively lock the necessary caster assemblies based on which hitch mount out of the plurality of hitch mounts the operator chooses to engage.

Power unit 12 includes the necessary fluid or electrical couplings (not illustrated) to provide hydraulic pressure or energy to frame 10. This pressure or energy operates to alter the dimensions of the frame. In a preferred embodiment, the power unit couplings from the power unit enter a junction box/controller that distributes the pressure or energy through a conduit system mounted to the various tubes.

A preferred means for changing the height and width dimensions of frame 10 is through hydraulic pressure supplied by power unit 12. In general, hydraulic controls and the means to hydraulically extend one tubular element relative to another tubular element are well known in the art. A hydraulic pump on the power unit (not illustrated) sends hydraulic pressure to the frame via the power unit couplings. The hydraulic pressure actuates hydraulic cylinders located in the frame tubes.

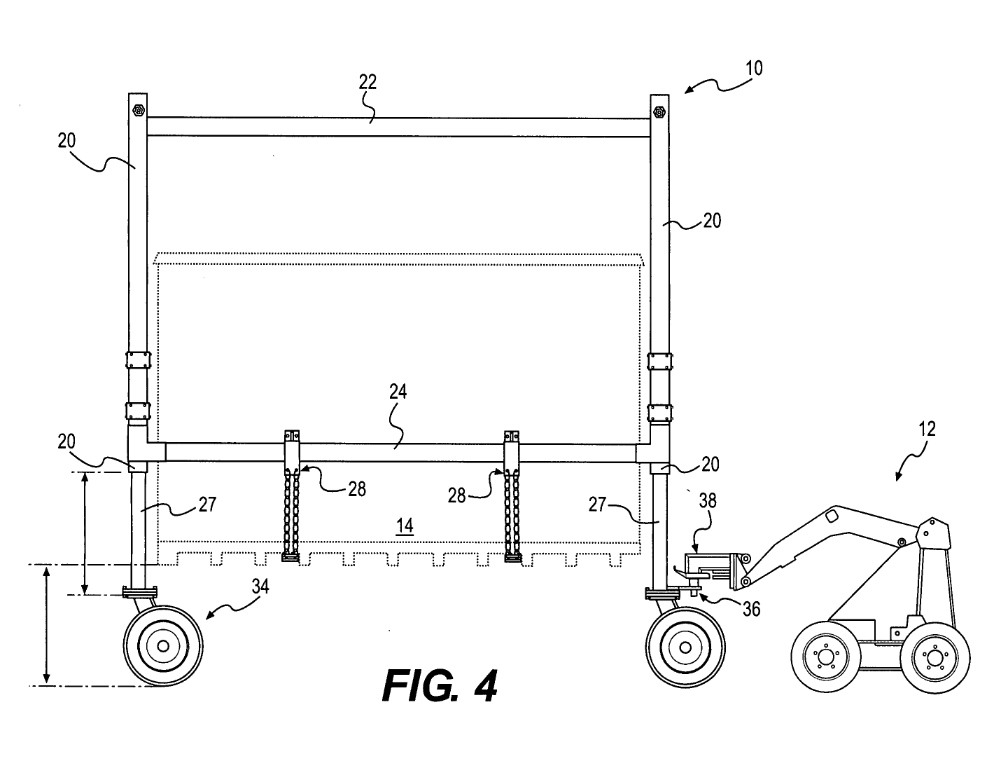

FIG. 4 illustrates the present invention wherein the height of the frame has been raised by hydraulically extending legs 27 relative to posts 20. As lower cross-members 24 are lifted away from the surface upon which frame 10 rests, connectors 28 between frame 10 and container 14 lift container 14 off of the surface/ground. Once lifted, it is possible to relocate frame 10 and container 14 via the self-propelled power unit.

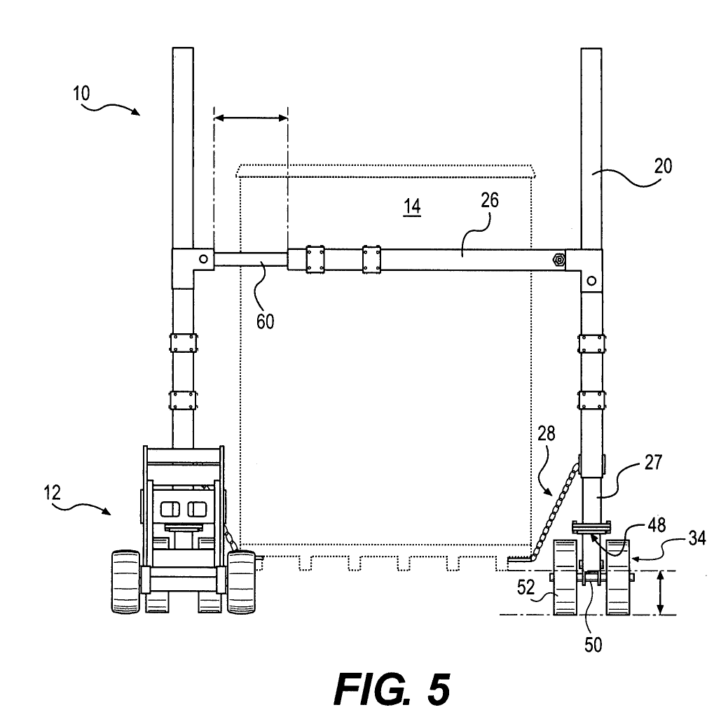

As briefly discussed above, it is also desirable to change the width dimensions of frame 10. Therefore, end-tubes 26 are in a slidable relationship with fixed interior tubular elements 60. FIG. 5 illustrates one end of frame 10 wherein end- tube 26 is hydraulically actuated to expose interior tubular element 60. Exposing fixed element 60 increases the width of frame 10. As end-tube 26 slides to expose element 60, the wider frame 10 becomes. Hydraulic pressure can be reduced to move end-tube 26 over element 60, which decreases the width of frame 10.

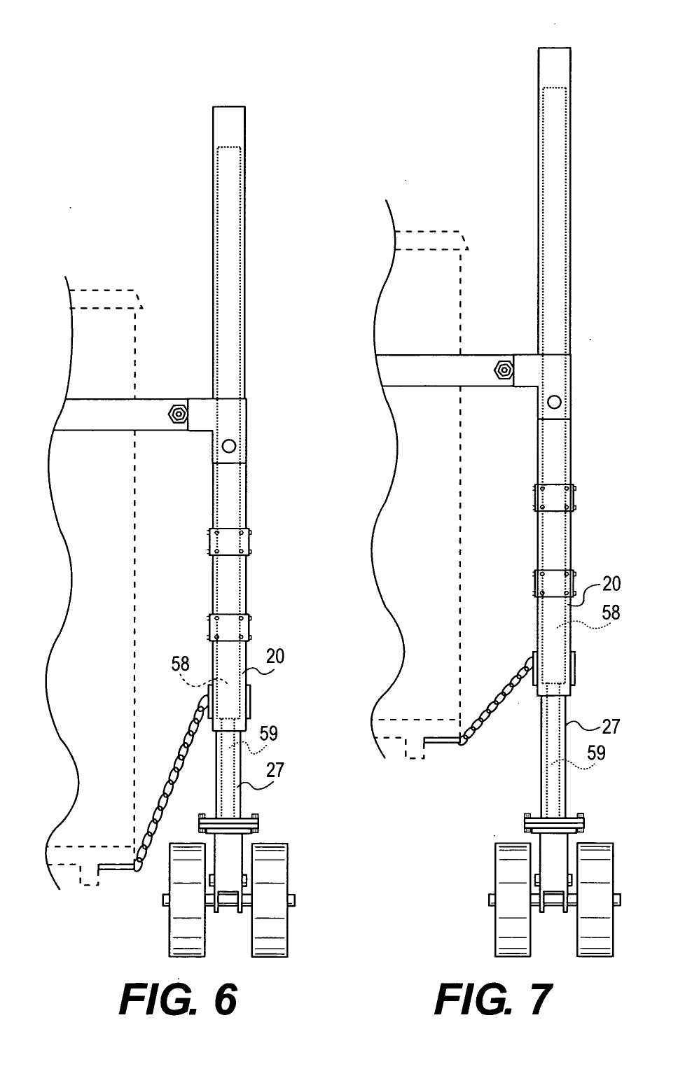

FIGS. 6 and 7 broadly illustrate the hydraulic components of frame 10. An internal bore 58 includes a rod 59. Hydraulic pressure moves rod 59 into and out of bore 58. The movement is transmitted to leg 27, which then extends and retracts relative to post 20.

The present invention includes hydraulic pressure equalizing valves (not illustrated) to balance the distribution of hydraulic force. In known temporary container delivery systems, the operator is required to individually actuate hydraulic cylinders or to manually distribute the lifting force. In a preferred embodiment of the present invention, the frame incorporates the equalizing valves to facilitate operation of the hydraulic cylinders. A valve is in fluid connection with the hydraulic cylinders located in the two posts that define one side of the frame. Each side of the frame includes such a valve. A third equalizing valve is in fluid connection with the hydraulic cylinders located in the end-tubes. The valves evenly distribute the hydraulic pressure between the hydraulic cylinders to which they are connected. As a result, each side of the frame extends the corresponding legs 27 at the same rate, and the width of the frame uniformly increases or decreases at both ends of the frame. Power unit 12 is motorized, self-propelled and is operable to relocate the frame when frame 10 is not connected to a container that is resting on a surface (i.e., there is no container attached to the frame or legs 27 are extended to the point that a connected container is no longer resting on the support surface). After securing the hitch mount, unit 12 is capable of steering the frame as desired in order for the power unit to position the frame to either deliver or extract container 14. The hydraulic/power couplings must be connected to change the frame's dimensions.

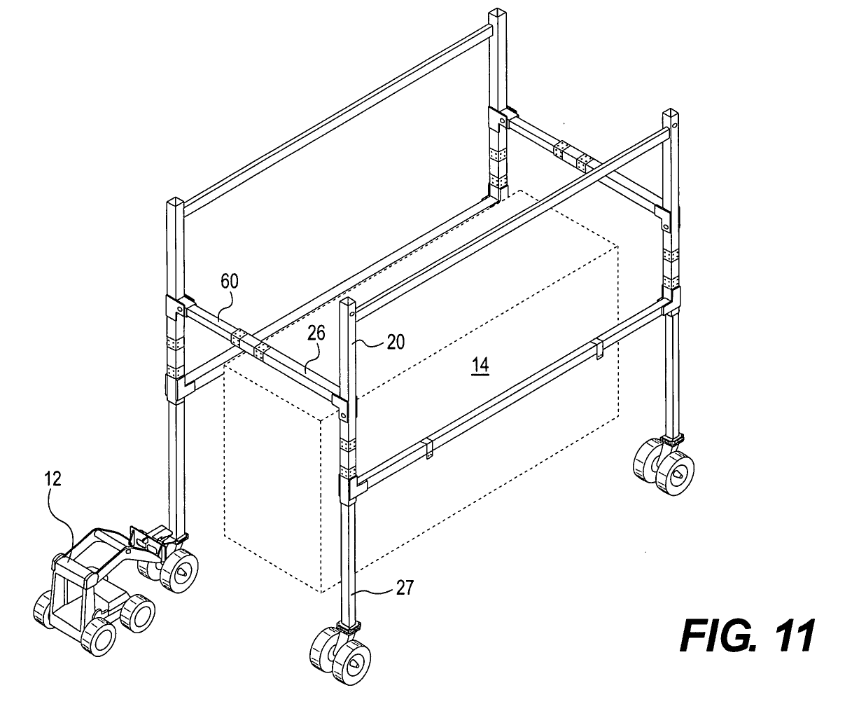

To deliver the container, the frame, while suspending the container, is pushed or pulled to the proper location by the power unit and legs 27 are hydraulically retracted into posts 20 to the point that container 14 rests upon a surface. Connectors 28 are disconnected from container 14. The operator then sends hydraulic pressure back to the frame in order to extend legs 27 to the extent that the height of end-tubes 26 exceed the height of container 14 (see FIG. 11). In this position, referred to as the lift position, it is then possible to drive or remove frame 10 from container 14 in either direction along the longitudinal axis of the container. The width of the frame is such that the power unit is outboard the width of the container. The ability to remove the frame in either direction is thought to be highly advantageous given the variety of locations to which a container may be delivered.

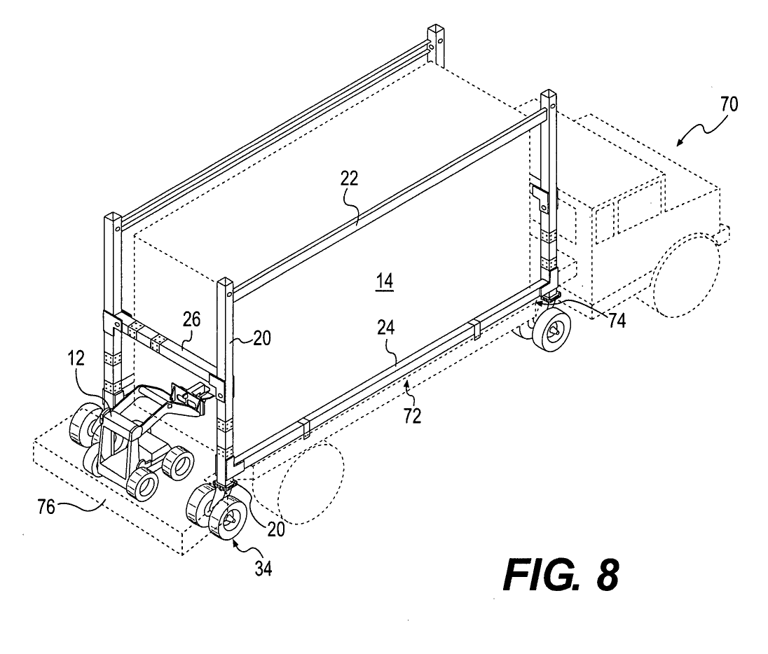

Although the power unit and frame can place the container once the assembly is on-site, it is still necessary to transport the frame, power unit, and container large distances between various sites. In this regard, as illustrated in FIG. 8, a transport vehicle 70 is provided. Vehicle 70 includes a flat bed loading surface 72. The bed includes channels or reduced width notches 74 that open to the sides of the bed/vehicle at four positions corresponding to the location of legs 27 on frame 10. Channels 74 are sized and dimensioned to accept legs 27.

The frame, container, and power unit are first loaded onto the transport vehicle. To accomplish this, hydraulic pressure from power unit 12 expands the width dimension of the frame until the distance between two posts 20 forming one end of the frame is larger than the width of bed 72. The height of the legs 27 is also adjusted to the point that the end-beams, cross members, and the bottom of container 14 are all higher than the top of bed 72. Power unit 12 then positions the frame so that legs 27 are aligned with notches 74. The width of frame 10 is then decreased to pull legs 27 into the channels. Power unit 12 is then disconnected from the hitch mount, and legs 27 are hydraulically retracted into posts 20 until lower cross members 24 rest upon bed 72 and wheel assemblies 34 are no longer in contact with the ground. The hydraulic couplings from the power unit may be disconnected at this point.

Power unit 12 is mounted to the rear of bed 72 by a known mounting technique, such as a elevator platform 76. Finally, the caster assemblies are preferably locked against rotation. The vehicle is then operable to deliver container 14, frame 10, and power unit 12 to a desired location.

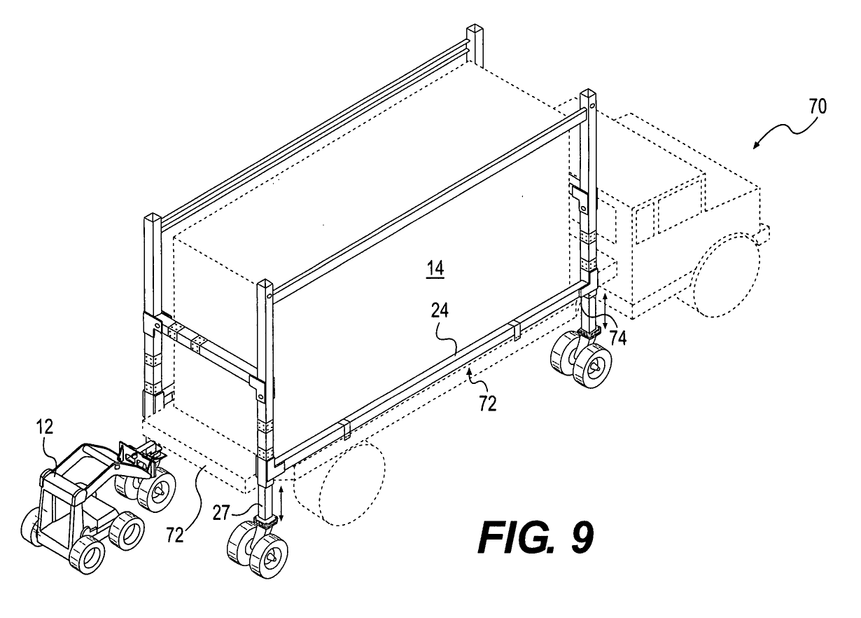

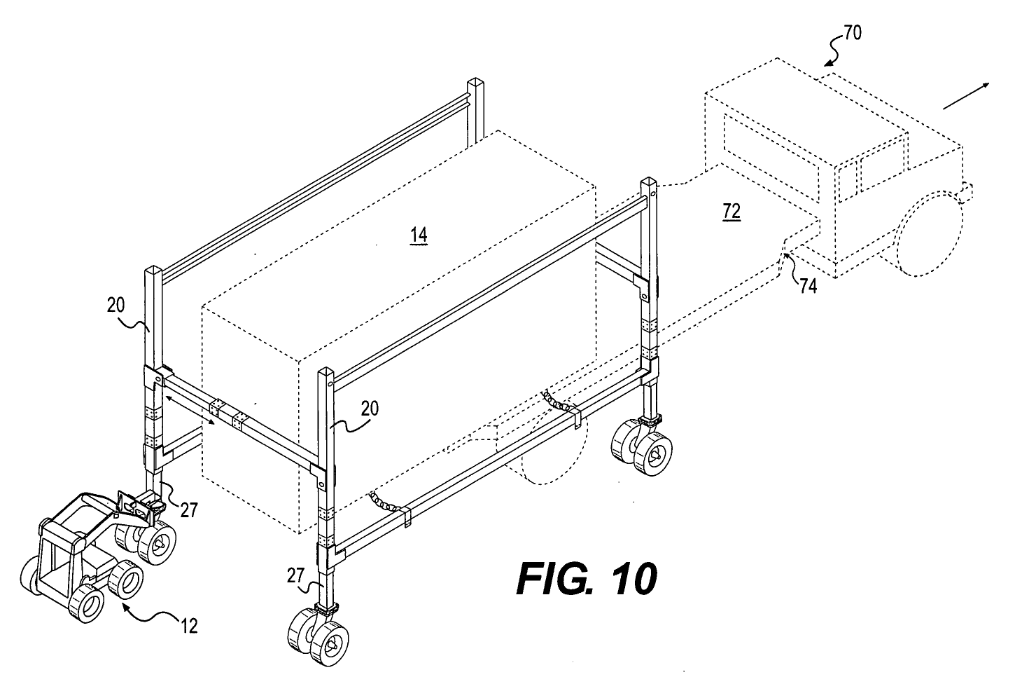

To unload frame 10, the process is basically reversed. Vehicle 70 arrives at a site where container 14 is to be delivered. Frame 10, power unit 12, and container 14 are all located on the vehicle's flat bed 72 (see FIG. 8). The caster assemblies are first released for rotation. Power unit 12 is unloaded from bed 72 and placed in hydraulic or electrical connection with frame 10 (again, couplings not illustrated). Legs 27 are extended from posts 20 until the wheel assemblies are on the ground (see FIG. 9). The legs extend until frame 10 lifts container 14 off the bed via connectors 28. The hitch receiver on power unit 12 is coupled to the hitch mount provided by one of the legs at the rear of vehicle 70. The width of frame 10 can then be expanded. Power unit 12 then pulls the frame and container away from the vehicle. It is also envisioned that vehicle 70 might drive away once frame 10 is clear of bed 72 (see FIG. 10). It is likely that legs 27 will be partially retracted to create a lower center of gravity prior to pushing or pulling the frame to the desired delivery location.

Although the present invention has been described in terms of at least one preferred embodiment, it will be understood that numerous variations and modifications may be made without departing from the invention. Such variations and modifications will become apparent and obvious to one skilled in the art, and all equivalent relationships to those illustrated in the drawings and described in the specification are intended to be encompassed by the present invention. Thus, it is to be understood that within the scope of the appended claims, the invention may be practiced otherwise than as specifically described above.

What is claimed is:

1. An apparatus for transporting, delivering, or otherwise positioning a portable storage unit, the apparatus comprising:
a wheeled frame, the frame having height, width, and length dimensions with four corners defining two sides and two ends, the frame including:
a vertical post at each of the four corners,
a leg extending from the lower end of each post, the leg being selectively extendable or retractable relative to the post to change the vertical height of the frame,
a selectively pivotable wheel assembly supporting each leg,
a cross-member on each side of the frame, each cross-member connected to two of the posts,
an end-tube on each end of the frame, each end-tube connected to two of the fixed posts,
an interior tubular element in each end-tube, the end-tube selectively slidable upon the tubular element to change the width of the frame,
at least one connector that connects the frame to the portable storage unit,
at least one hitch mount on the frame,
a self-propelled power unit selectively secured to the at least one hitch mount, the power unit including selectively attached couplings to transfer energy from the power unit to the frame to change the dimensions of the frame, the self-propelled power unit operable to move the frame across a surface, and the power unit being positionable independent of the frame; and
wherein the frame and the selectively removable power unit are effective to lift and position the portable storage unit.

2. The apparatus of claim 1, wherein each selectively pivotable wheel assembly further comprises an upper plate joined to the bottom of the corresponding legs, a revolving caster assembly connecting a rotatable wheel to the upper plate, and a selectively removable pin wherein the pin is operable to lock the revolving caster assembly in place.

3. The apparatus of claim 1, wherein the vertical posts and legs slide relative to each other via hydraulic cylinders that motivate the leg to slide relative to the corresponding post and wherein the selectively removable power unit supplies the hydraulic pressure to actuate the hydraulic cylinders.

4. The apparatus of claim 1, wherein the end-tubes and the interior tubular elements slide relative to each other via hydraulic cylinders that motivate the end-tube to slide relative to the corresponding tubular element and wherein the selectively removable power unit supplies the hydraulic pressure to actuate the hydraulic cylinders.

5. The apparatus of claim 1, further comprising a lift position for the frame, the lift position describing a position wherein the legs extend from the corresponding posts a sufficient distance to raise the end-tubes of the frame above the height of the container; and
wherein the power unit is operable to separate the location of the frame from the location of the container by motivating the frame away from the container when the frame is in the lift position.

6. The apparatus of claim 1, wherein the at least one connector that connects the frame to the portable storage unit further comprises a chain, the at least one chain being secured to the frame at a first end and secured to the portable storage unit at a second end.

7. The apparatus of claim 6, wherein the at least one chain is secured to a cross-member at the first end of the chain.

8. The apparatus of claim 1, wherein the wheeled power unit includes a hitch receiver selectively secured to the hitch mount, the hitch mount comprising a ball mount assembly.

9. The apparatus of claim 1, further comprising a transport vehicle, the transport vehicle including a flat bed; and wherein the bed includes channels sized and dimensional to accept the legs and a mounting system to support the power unit.

10. An apparatus for transporting, delivering, or otherwise positioning a portable storage unit at a specific location, the apparatus including a dimensionally adjustable frame, the apparatus comprising:
a plurality of selectively pivotable wheel assemblies supporting the frame for movement across a support surface;
at least one connector that connects the frame to the portable storage unit;
at least one hitch mount connected on the frame;
a self-propelled power unit selectively coupled to the frame, the power unit including a hitch receiver selectively secured to the at least one hitch mount, the power unit including hydraulic couplings mated to the frame, the dimensions of the frame controlled by actuating hydraulic cylinders in the frame via hydraulic pressure supplied by the power unit, the propulsion of the wheeled power unit effective to motivate the frame across the support surface; and
wherein the frame and the selectively removable power unit are operable to lift and position the portable storage unit.

11. The apparatus of claim 12, further comprising a transport vehicle, the frame and power unit operable to be stored on the transport vehicle.

12. The apparatus of claim 12, wherein each of the plurality of selectively pivotable wheel assemblies further comprise an upper plate secured to the corresponding leg, a revolving caster assembly connecting a rotatable wheel to the upper plate, and a selectively removable pin wherein the pin is operable to lock the revolving caster assembly in place.

13. The apparatus of claim 12, wherein the frame is constructed of pairs of nested tubes, each tube in the pairs of nested tubes arranged in a sliding relationship to the other tube of the pair, a plurality of hydraulic cylinders operable to slide one tube in each pair relative to the second tube.

14. The apparatus of claim 12, wherein the least one connector that connects the frame to the portable storage unit further comprises a chain, the at least one chain being secured to the frame at a first end and secured to the portable storage unit at a second end.

15. A method of relocating a temporary storage container:
driving a transport vehicle to a desired location, the transport vehicle supporting a storage container, a wheeled frame, and a self-propelled power unit wherein the frame is linked to the storage container;
creating a hydraulic connection between the self-propelled power unit and the frame;
supplying hydraulic pressure to increase the height of the frame and storage container relative to the transport vehicle;
furnishing hydraulic pressure to increase the width of the frame;
using the self-propelled power unit to move the wheeled frame;
removing hydraulic pressure to reduce the height of the frame in order to rest the storage container on a surface;
disconnecting the storage container from the frame; and
repositioning the frame on the transport vehicle via the self-propelled power unit.
